(19) United States
(12) Patent Application Publication
(10) Pub. No.: US 2008/0208908 A1
(43) Pub. Date: Aug. 28, 2008

(54) System and method for synchronization of user preferences in a network of audio-visual devices

(76) Inventors: Praveen Kashyap, Irvine, CA (US); Gaurav Srivastava, Irvine, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/712,537

(22) Filed: Feb. 28, 2007

(51) Int. Cl. G06F 17/30

(52) U.S. Cl. 707/104.1; 707/E17.009

(57) ABSTRACT

A system and method for synchronizing user preferences in a network of audio-visual devices is disclosed. According to various embodiments, networked audio-visual (AV) devices are configured to store device settings applicable to other devices on the network. Account data related to users of the network is stored in a database distributed across the network. Device settings for the AV devices are associated with network users and are synchronized among the various devices. The devices are configured to apply user preferences, thereby allowing logged in users to receive a personalized experience regardless of which device in the network they use.

### BACKGROUND OF THE INVENTION

1. Field of the Invention

This application relates to home audio-visual (AV) networks. In particular, this application relates to a system and method of synchronizing user preferences among a plurality of AV devices in a home AV network.

2. Description of the Related Technology

Currently, as home AV networks become more prevalent, consumers are adding more devices to these networks. Many of today's AV devices such as televisions, set top boxes, DVD players, personal video recorders (PVRs), music players, and other types of systems allow a user to store preferred settings on the device. For example, a set top box may allow a user to specify favorite channel lists that allow the user to easily access preferred content without needing to scroll through lists of all available channels. Televisions can be configured to block certain types of content using parental control devices.

In multi-device network environments, each device must typically be configured individually when added to the network. As a result, if a general setting which is common to several devices is to be changed, then it must be changed individually on each device. Moreover, the device-specificity of settings on current networked AV devices do not account for use by different people. For example, a family room television may be watched at different times by a parent and a child. The parent and child may have different preferred settings, but there is no mechanism to individualize these preferred settings among users. As a result, it would be an improvement and an advancement in the art to provide a networking solution which alleviates and/or eliminates the shortcomings described above.

### SUMMARY OF CERTAIN INVENTIVE ASPECTS

The system, method, and devices of the present invention each have several aspects, no single one of which is solely responsible for its desirable attributes. Without limiting the scope of this invention, several of its features will now be discussed briefly.

One aspect is a system of providing a user-centric environment in a home network environment. The system includes a plurality of networked AV devices, each device configured to store device settings. The system further includes a user management module configured to sore account data related to a plurality of users of the home network. The user management module is also configured to associate the stored device settings with at least one of the plurality of users. A device settings management module is also configured to synchronize user preferences among the plurality of networked AV devices.

Another aspect is a method of delivering user-specific content in High-Definition Audio-Video Network Alliance (HANA) network environment. The network includes a plurality of connected AV devices. The method includes creating a plurality of user accounts for accessing the HANA network. User preferences are synchronized among each of the devices connected to the HANA network. The method further includes detecting a change to a user preference on a first device connected to the network. The change to the user preference is then propagated to each of the AV devices on the network.

### BRIEF DESCRIPTION OF THE DRAWINGS

In this description, reference is made to the drawings wherein like parts are designated with like numerals throughout.

FIG. 1 is a block diagram illustrating various components in a network-enabled AV device.

FIG. 2 is a block diagram of an exemplary AV network according to various aspects of the invention.

FIG. 3 is an example of a database table schema which may be used to store device preferences.

FIG. 4 is a flowchart illustrating a process by which user settings and device preferences are synchronized according to one or more embodiments.

FIG. 5 is a flowchart illustrating a process in which a personalized user experience is provided on AV devices in the network.

FIG. 6 is a flowchart illustrating a method of delivering user-specific content in an expandable home theater (HANA) network environment.

### DETAILED DESCRIPTION OF CERTAIN INVENTIVE EMBODIMENTS

Various embodiments of the invention provide for systems and methods which allows users of an audio-visual (AV) network to receive a personalized user experience when accessing any device on the network without having to download personalized settings each time they access the device. This personalized user experience is generally obtained by passing user settings input into one device on the network to some or all of the other devices on the network, and maintaining these settings by distributing detected changes to each of the other devices in the network. For example, a user's settings on living room HDTV may be available on other HDTVs in parent bedroom or child bedroom. More general settings such as a default volume level may be available on all devices on the network.

The systems and methods described herein may be deployed within the context of a networked environment of network-enabled audio visual devices. As used herein, an audio-visual (AV) device may refer to any device that is used to provide access to audio and/or visual content. Well-known examples of AV devices are televisions (both high definition and conventional), DVD players, audio players, stereo systems, personal video recorders (PVR), television set top boxes, radios, etc. Network-enabled refers to the ability of an AV device 100 to send data to and/or receive data from a wired or wireless network.

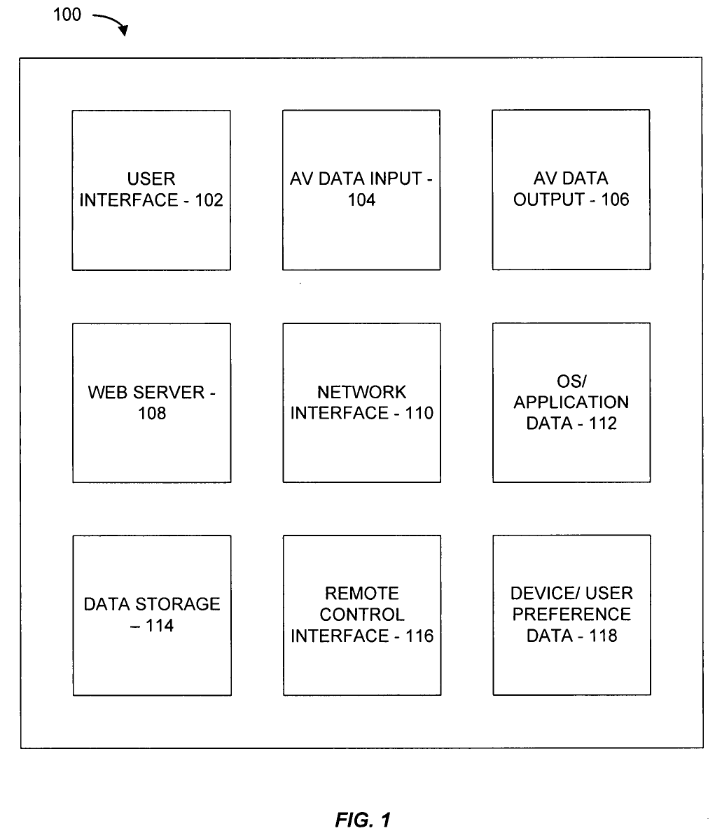

FIG. 1 is a block diagram which provides an illustration of various components of an exemplary network-enabled audio-visual device 100. Although the AV device 100 shown in FIG. 1 includes various components, a skilled technologist will appreciate that AV devices 100 may include additional working components, and that each of the components provided in FIG. 1 is not necessarily present in each AV device 100. The AV device 100 typically includes a user interface 102. The user interface 102 is typically used to allow the user to interact and control various functions of the device. By way of example and not limitation, a user interface for a television may take the form of a control settings menu which is displayed on the screen. Similarly, a user interface for a PVR may take the form of an electronic program guide which also is displayed on a television to which the PVR is connected. User interfaces for other devices such as DVD players and audio playing devices may also be displayed on a television screen, or may alternately be accessed via some display on the device itself such as an LCD display and associated menu buttons.

The AV device 100 also typically includes an AV data input 104 which is used to receive audio-visual data from an external source. The AV data input 104 may take various forms. The AV data input 104 may be a coaxial interface which receives coaxial cable input. The AV data input 104 may also be a DVI channel or even a network input such as an Ethernet port, a firewire port, a USB port, or some other input. The AV device 100 may also include a AV data output 106. The AV data output 106 is used to send the AV data received by the AV data input 104 (or generated by the AV device 100 itself) and provide the AV content to the consumer. Different AV devices may have different types of data output. For example, the AV data output in a television may include a television screen and speakers for playing sound. A data output for a PVR may take the form of a DVI channel over which AV data is sent for display by the television.

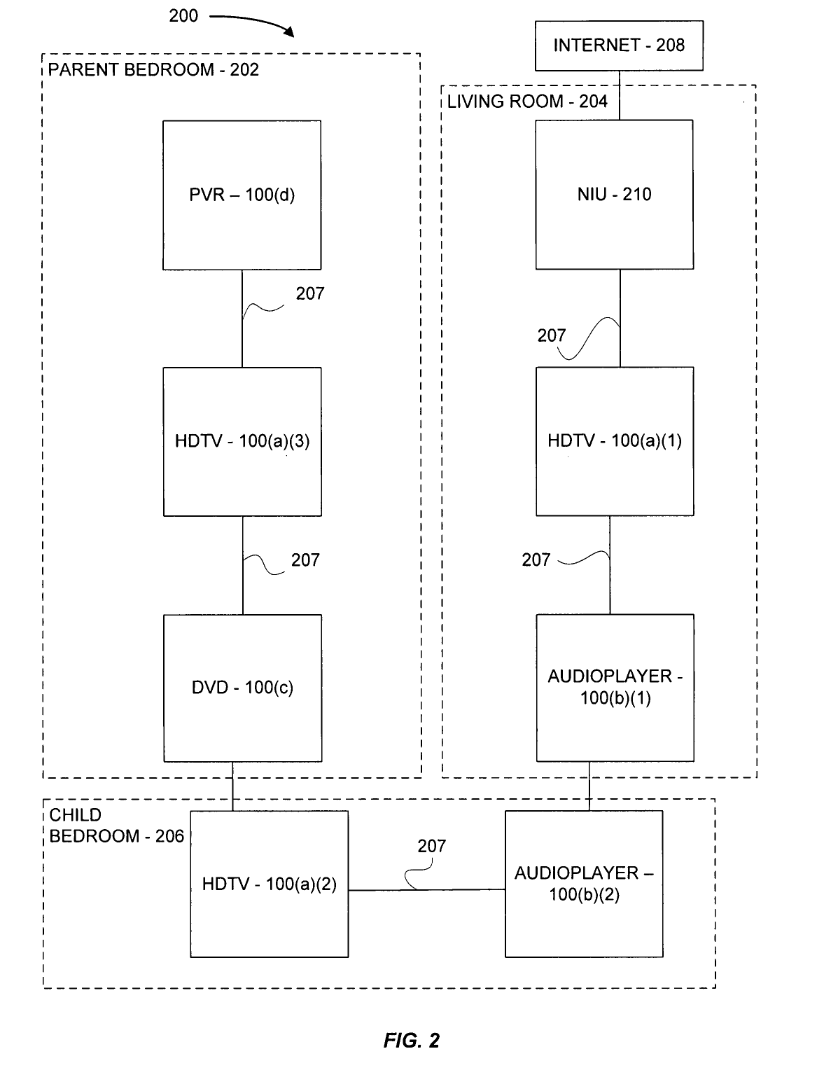

As will be discussed in further detail below with respect to FIG. 2, the AV device 100 in this context is connected to a network. As such, it may include various components to facilitate network communication. For example, the AV device 100 includes a network interface 110 which provides the ability to send and receive data over a network connection. The network interface 110 may include a network interface card for receiving network wires. The network interface may also take the form of a wireless network card. The network interface 110 may be part of the AV data input 104 and AV data out 106, or it may be a separate component in the AV device 100. The AV device 100 typically further includes an operating system/software applications 112. The operating system/applications 112 may be a general computer operating system such as Linux, Windows®, MacOS®, or some other operating system with a software application running on top of the OS to control the device. The operating system may be stored in some storage media such as data storage 114. Data storage 114 may be any suitable type of computer memory. For example, data storage 114 may include volatile memory, nonvolatile memory, or both. The data storage 114 may further store other data such as server data for a web server 108. Also stored in data storage 114 may be device settings 118 which, as noted above, may be controlled and set via the user interface 102.

As will be discussed in further detail below, the server 108 may be used by the AV device 100 to accept data request from other AV devices 100, and to respond to the requests by sending data through the network interface 110. The server 108 may take the form of an HTTP web server such as an Apache-based server, or it may be some other type of web server. The AV device 100 may also include application data 118. Depending on the type of AV device 100, the application data 118 may take various forms. In a PVR, for example, the application data 118 may include a PVR user application such as Tivo® software or some other type of PVR software that records video to the data storage. In a audio playing device, the application data 118 may include audio playing software. In other devices, other applications 118 may be present. Each AV device 100 may also include a remote control interface 116. The remote control interface 116 allows the AV device to be accessed and controlled by a remote control device. As will be discussed in further detail below, in some embodiments the remote control interface 116 may be configured to accept input from a “universal” remote control, which allows all devices in a network to be controlled by a single remote control device.

As noted previously, system and methods described herein may be implemented within a home AV network environment. Referring now to FIG. 2, an example of a home network 200 is provided. The home network 200 may be used to connect various AV devices 100 in such a way that they may share data and communicate with each other. The home network 200 may take the form of a network which conforms to a standard protocol such as the Consumer Electronics Association (CEA) standard 2027. This CEA standard defines a user-to-machine interface method which allows a source of home-network services, such as a cable or terrestrial set-top box, digital VCR, or DTV, to utilize the presentation capabilities in a network-attached rendering device such as a DTV display or PC. The standard also provides a protocol which enables user control of networked devices (either local to the user or remote) via another device's (e.g., DTV or PC) web browser graphical user interface (GUI).

In one embodiment, the home network 200 may be a single line network such as, for example, an High-Definition Audio-Video Network Alliance (HANA) network which uses an IEEE 1394 connection (e.g., “Firewire”) between devices. In other embodiments, the network 200 may be an Ethernet network, or some other network. The connections between devices may be wired or wireless.

FIG. 2 provides an exemplary view of a HANA home network 200. Although a specific network configuration and environment is shown in FIG. 2, a skilled technologist will appreciate that this environment is merely an example of an environment suitable for practicing various aspects and embodiments of the invention, and that other configurations and environments are also suitable. The home network 200 includes various AV devices 100(a)-100(d) located in a parent bedroom 202, a living room 204, and a child bedroom 206. Each of the devices 100(a)-100(d) can communicate via a IEEE 1394 connection to their respective network interfaces 110. In the exemplary environment illustrated in FIG. 2, the HANA network is connected to a wide area network (WAN) 208 via a network interface unit 210 which is located in a living room 204. The NIU 210 may be a router, a set top box, a satellite dish, or some other channel to a larger communications network. The WAN 208 may be a cable television network, the Internet, or some other network that channels AV content into the HANA network 200. Although the NIU is shown is being located in a specific location in this example, it is readily understood that the NIU may be located in various physical locations within a HANA network.

Also in the living room 204 are AV devices 100. In the example provided, the living room 204 includes a high definition television (HDTV) 100(a)(1) and an audio playing device 100(b)(1), such as a digital media player for example each connected via the network connection 207. The devices in the living room 204 are connected to devices in the child bedroom 206 via the network connection 207. The child bedroom 206 includes an audio playing device 100(b)(2) and another HDTV 100(a)(2). The HDTV 100(a)(2) in the child bedroom 206 communicates via the network connection 207 with the DVD 100(c) located in the parent bedroom 202. The parent bedroom 202 also includes a third HDTV 100(a)(3) and a PVR 100(d).

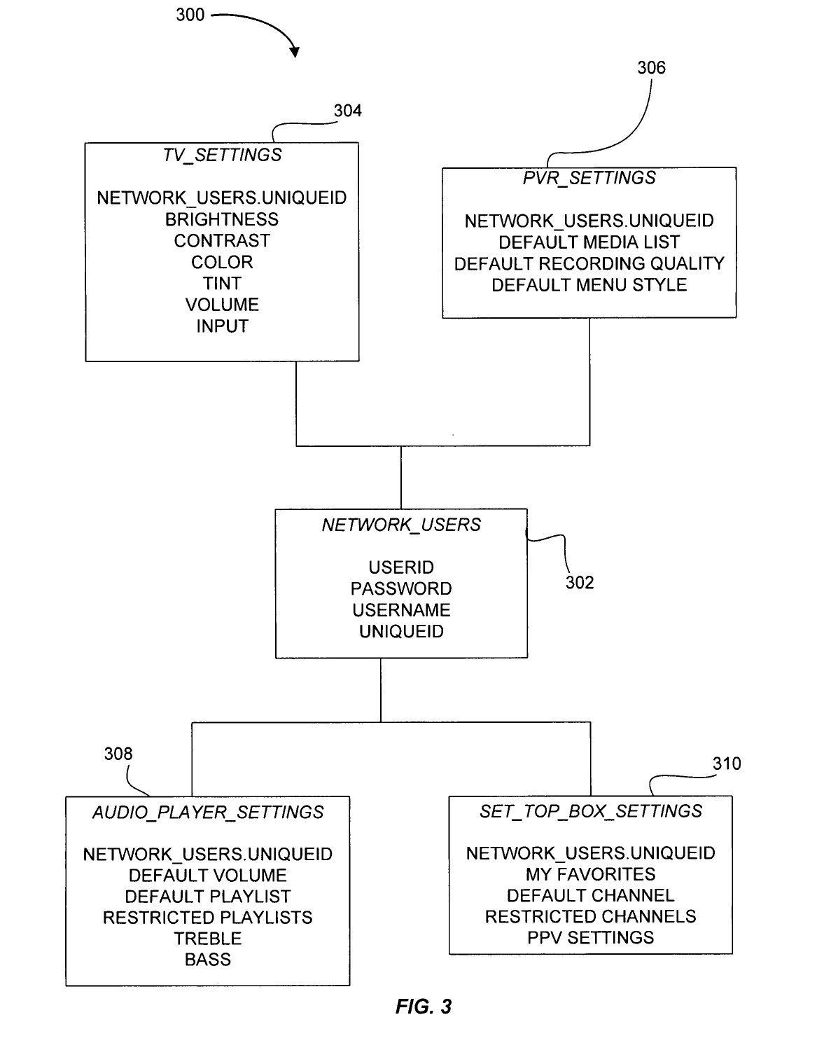

As noted above, each of the AV devices 100 includes device settings 118 that may be stored in data storage 1114. According to one or more embodiments, these device settings 118 may be shared among devices 100(a)-100(d) so that they need only be set once for each type of device. For example, when a user accesses HDTV 100(a)(3) located in the parent bedroom and sets certain device settings 118, those settings may be shared with other devices 100 on the network 200 so that when the user accesses the HDTV 100(a)(1) located in the living room, the same device settings 118 are automatically present. In some embodiments, these device settings 118 may be stored in a distributed database 300 (FIG. 3) which is shared and replicated among each of the devices on the network 200. In addition, these settings may be associated with a particular user of the device, which allows the user experience to be personalized to a greater extent.

FIG. 3 provides an example of a schema for a shared distributed database 300. The shared distributed database 300 may be stored in the data storage 114 and shared among devices via the network connection 207. The database 300 may be a relational database, an object-oriented database, a flat file database, or some other type of database. In the example provided, the database 300 is a relational-type database having a plurality of database tables storing related data. The database 300 may include a network users table 302 which stores data about users that are authorized to access the network 200. This type may include a user identifier field, a password field, and a unique identifier that may be passed among devices 100 in the network 200 to determine which user is accessing a particular device.

The database 300 may also include data tables which store information including device settings 118 for each different type of device that may be added to the network environment 200. In the example shown in FIG. 3, these tables include a television settings table 304, a PVR settings table 306, an audio player settings table 308, and a table for storing set top box settings 310. A DVD settings table (not shown) may also be included, as well as a table for additional device types. Each device-oriented table 304-310 includes a field “NETWORK_USERS.UNIQUEID” which allows the settings stored in the field to be specific to a particular user of the network 200. Thus, when the user accesses a device 100 on the network 200, the database may be queried for the settings specific to the user UNIQUEID which is logged into the network.

As shown in the figure, television settings table 302 may include data fields for items such as brightness, contrast, color, tint, volume, and default data input (such as DVI or Coaxial, for example). The PVR settings 304 may include a data field for storing data such as the default media list (such as satellite, cable, or over the air), default recording quality (such as basic, normal, or highest), and default menu (such as grid or table) for the PVR device. The audio player settings 306 may include a data field for storing items such as default volume (when the device is turned on), default playlist, restricted playlists (i.e., the playlists not available to a particular user). The restricted playlists may be useful in an environment where children access the AV device and should be permitted to access certain types of content. The audio player settings 306 may also include default settings for sound control such as treble and bass. The database 300 may also include set top box settings 310. The set top box settings 310 may include data field for items such as favorite channels, default channel, restricted channels, and pay-per-view settings and permissions. As with the restricted playlists, utilizing restricted channels and defining this data on a per user basis allows for the home network 200 to make inappropriate content inaccessible to certain users.

According to various embodiments, the database 300 shown in FIG. 3 may be replicated and synchronized on each device 100 in the network 200. Thus, each device 100 may store in its data storage area 114, a copy of the database 300. Because each device maintains the preferences for each user and each of the other devices, when a device 100 is removed from the network 200, user preferences for the other devices are always maintained. Alternatively, the database 300 may be divided into separate databases based on the type of device. For example, the HDTVs 100(a)(3) may share a database, while the audio playing devices 100(b)(1) and 100(b)(2) may share a separate database. In this configuration, changed settings are propagated among similar devices which share a common database, allowing for less necessary storage capability on the devices in the network 200. Moreover, because the network 200 may be configured to require a user authentication to utilize the network-enabled devices 100, each device accessed by a user can be configured to load the preferences and settings specific to the user, regardless of the location of the device.

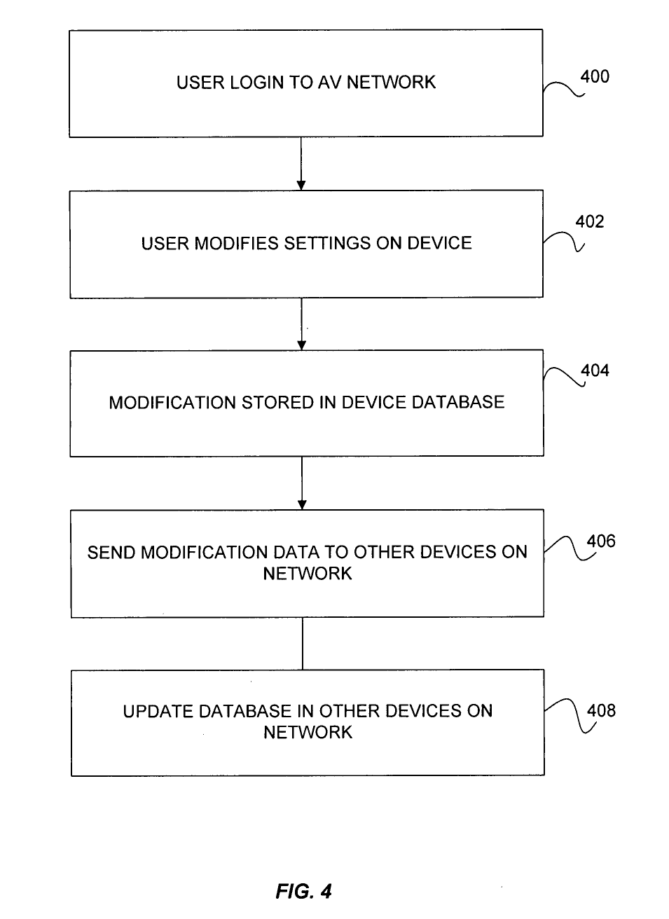

FIG. 4 is a flowchart illustrating a process by which a personalized user experience is provided to control the system described in FIGS. 1-3 above. The process begins at block 400, where the user logs into the AV network 100. The process for logging into the network may take various forms. For example, in one embodiment, the user may input a username and password using a universal remote control that is configured to control each device 100 in the network 200. In other embodiments, the remote control may be equipped with a biometric sensor such as a fingerprint scanner which may be used to identify the user when the user grips the remote control device. The remote control device may send the user credentials (i.e., the finger print) to the network via a remote control interface 116 of one or more of the devices 100, where the fingerprint may be matched against an authentication fingerprint stored in the database 300. In still other embodiments, the remote control device may include a voice recognition interface that allows the user to be authenticated to the network 200 by a voice command. The voice command may be compared to an authentication credential stored in the database 300 or in some other part of the network 200 to determine the user accessing the network. Upon authentication to the network 200, the user may then begin using devices 100 on the network to gain access to AV content.

Once the user has been authenticated to the network 200, the process moves to block 402 where the user modifies settings 118 on one or more of the accessed AV devices 100. Examples of device modifications may include adjusting the picture on a HDTV device 100(a) by making it brighter or less bright, or creating a new playlist on the audio playing device 100(b), or some other adjustment. When the adjustment is made to the device setting, the process then moves to block 404 where the specific modification is stored in the appropriate table of the database 300 on the device 100 being modified. As noted previously, each AV device 100 includes a copy of the database 300. Once the modification has been successfully stored in the database 300, the modified data is then sent to the databases 300 located in the other devices 100 on the network 200 along with an instruction to update the databases with the new data. The instruction may be an SQL commend, for example. Next, at block 408, the instructions and data are received by the other devices 100 on the network 200, and the databases 300 on those devices 100 are updated accordingly.

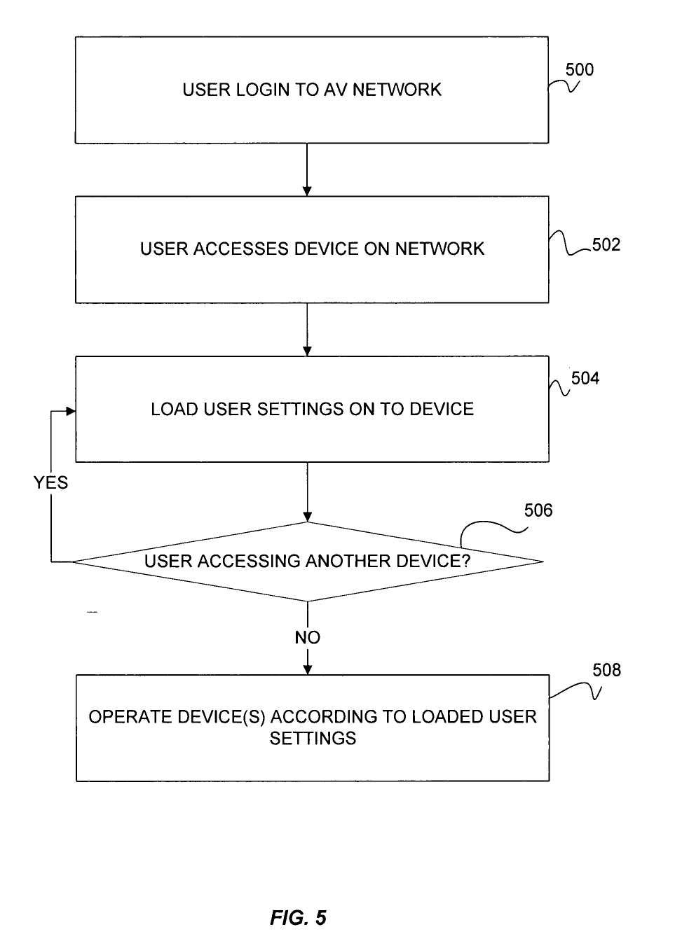

Referring now to FIG. 5, a flow diagram showing how user settings and device preferences can be synchronized utilizing the system described in FIGS. 1-3 above according to still additional aspects of the invention. The process begins at block 500 with the user logging into to the AV network 200 in a similar manner as described above in connection with FIG. 4. Once the user has logged into the network, he accesses a device 100 on the AV network 200. As noted above, the user may access the device utilizing a remote control that interfaces with the remote control interface 116 of the AV device 100. When the device receives input from the remote control, it determines which user is logged in and queries its settings database for the appropriate preferences and settings to load onto the device. At block 504, the retrieved settings are loaded onto the device. In many instances, a user will use more than one AV device at the same time. For example, a user may access both an HDTV 100(a) and a PVR 100(d) simultaneously. To ensure that a personalized user experience is provided for each device accessed by the user, after loading the device preferences for the first device at block 504, the system then checks at block 506 to determine whether the user is accessing another device. If so, process returns to block 504 where the database on the second device is queried for the appropriate settings, and the settings are loaded onto the device. This process may be repeated for each additional device 100 accessed by the user. Once the device settings have been loaded for the devices, the process may then move to block 508, where the device then operates according to the loaded device preferences and settings.

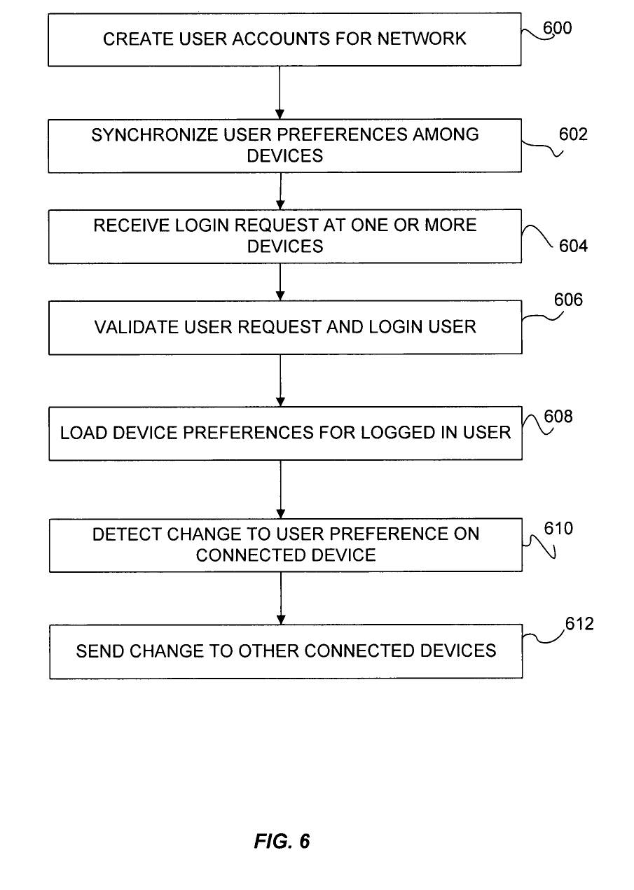

In still another embodiment, the processes described in FIGS. 4 and 5 may form portions of a more general method for delivering user-specific content in an HANA home network environment. FIG. 6 is a flowchart illustrating such a method. With reference to FIG. 6, the method begins at block 600, where user accounts are created for the HANA network 200. As noted previously, data related to the user accounts may be stored in the data storage 114, and more specifically may form part of the device preferences database 300. Once the user accounts have been created, user preferences associated with the created accounts may be synchronized among devices 100 on the network. Next, at block 604, the network 200 may receive a login request from a user at one or more of the devices 100 on the network. The process then moves to block 606, where the user is validated and authenticated to the network 200. The user validation and authentication may be handled by the OS/application data 112 stored on the device. Next, at block 608, the device preferences for the logged in user are downloaded from (?) into each of the accessed devices so that the user is able to access their preferred content and device settings. In the course of using the AV devices 100, the user may make a change to his preferences or settings. When such a change is made, the process moves to block 610, where the change is detected by the network application. The change is stored in the database 300 of the device and then replicated to the database 300 on each of the other devices on the network 200.

It will be understood by those of skill in the art that numerous and various modifications can be made without departing from the spirit of the present invention. Therefore, it should be clearly understood that the forms of the invention are illustrative only and are not intended to limit the scope of the invention.

What is claimed is:

1. A system of providing a user-centric environment in a home network environment, the system comprising:
a plurality of networked audio-visual (AV) devices, each device configured to store device settings;
a user management module configured to store account data related to a plurality of users of the home network, and further configured to associate the stored device settings with at least one of the plurality of users; and
a device settings management module configured to synchronize user preferences among the plurality of networked AV devices.

2. The system of claim 1, wherein each of the plurality of devices stores device settings for all devices on the network.

3. The system of claim 2, wherein each of the plurality of devices stores device settings for all users on the network.

4. The system of claim 3, further comprising an authentication module configured to identify a user accessing at least one of the AV devices and further configured to load stored device settings associated with the identified user for each accessed AV device.

5. The system of claim 4, wherein the authentication module is further configured to identify the user by receiving login credentials from the user via a device control module.

6. The system of claim 5, wherein the login credentials comprise a user identifier and password.

7. The system of claim 3, wherein if a device is removed from the network, the settings for the removed device remain stored in other devices on the network.

8. The system of claim 1, wherein the network is a single line network.

9. The system of claim 8, wherein the network is an eXpandable Home Theater (HANA) network.

10. The system of claim 9, wherein the content devices comprise one or more of a high definition television, a set top box, a DVD player, a personal video recorder, and a music playing device.

11. A method of delivering user-specific content in a HANA network environment, the network having a plurality of AV devices connected thereto, the method comprising:
creating a plurality of user accounts for accessing the HANA network;
synchronizing user preferences among each of the devices connected to the HANA network;
detecting a change to a user preference on a first device connected to the network; and
propagating the change to the user preference by sending the modified user preference to each of the other AV devices on the network.

12. The method of claim 11, further comprising:
receiving a login request at one of the devices for one of the user accounts;
determining whether the login request is valid; and
loading device preferences associated with the user account onto the device if the request is valid.

13. The method of claim 12, wherein loading device preferences comprises:
accessing preference data associated with the logged in user stored in a database on the accessed device; and
modifying controllable settings of the accessed device based on the preference data associated with the logged in user.

14. The method of claim 11, wherein each of the plurality of AV device comprises data storage for storing preference data.

15. The method of claim 14, wherein synchronizing user preferences among each of the devices comprises storing the same preference data in each of the AV devices.

16. The method of claim 15, wherein propagating the change to the user preference comprises copying the changed data into the data storage on each of the other AV devices.

17. The method of claim 12, wherein determining whether the login request is valid comprises:
receiving a biometric signature from a remote control configured to operate at least one of the AV devices in the network; and
confirming the validity of the biometric signature.

18. The method of claim 17, wherein the biometric signature is received by a fingerprint scanner located on a surface of the remote control.

19. The method of claim 13, wherein when the logged in user discontinues use of the networked AV device, the networked AV device stores any modifications made to the device preferences associated with the user account.

20. The method of claim 12, wherein determining whether the login request is valid comprises:
receiving a voice command from the user into voice recognition system which is built into a remote control configured to operate at least one of the AV devices in the network; and
confirming the voice command as matching an authorized user account of the AV network.
